(19) United States
(12) Patent Application Publication
(10) Pub. No.: US 2026/0103055 A1
(43) Pub. Date: Apr. 16, 2026

(54) VEHICLE AIR CONDITIONING SYSTEM AND METHOD FOR USING AIR CONDITIONING DEVICE

(71) Applicant: NGK INSULATORS, LTD., Nagoya-City (JP)

(72) Inventor: Takafumi HAMADA, Nagoya-Shi (JP)

(73) Assignee: NGK INSULATORS, LTD., Nagoya-City (JP)

(21) Appl. No.: 19/180,277

(22) Filed: Apr. 16, 2025

(30) Foreign Application Priority Data
May 17, 2024 (JP) 2024-081161

(51) Int. Cl. B60H 3/06; B01D 53/96; B60H 1/00; B60H 3/02

(52) U.S. Cl. CPC B60H 3/06; B01D 53/96; B60H 1/00821; B60H 3/02; B01D 2253/3425; B60H 2003/028; B60H 2003/0691

(57) ABSTRACT

A vehicle air conditioning system includes: an air conditioning duct through which air can flow; an air conditioning device including: a honeycomb structure having an outer peripheral wall and partition walls disposed on an inner side of the outer peripheral wall, the partition walls defining a plurality of cells, each of the cells extending from a first end face to a second end face to form a flow path for the air; and an adsorbing layer containing an adsorbent, the adsorbing layer being provided on each surface of the partition walls, the air conditioning device being disposed in the air conditioning duct; and a control unit capable of controlling a flow velocity of air flowing through the cells of the air conditioning device.

### CROSS REFERENCE TO RELATED APPLICATIONS

The present invention claims the benefit of priority to Japanese Patent Application No 2024-081161 filed on May 17, 2024 with the Japanese Patent Office, the entire contents of which are incorporated herein by reference in its entirety.

### FIELD OF THE INVENTION

The present invention relates to a vehicle air conditioning system and a method for using an air conditioning device.

### BACKGROUND OF THE INVENTION

In various types of vehicles such as automobiles, there are increasing requirements for improvement of vehicle interior environment. Specific requirements illustrate reduction of an amount of CO₂ in the vehicle interior to suppress driver's drowsiness, control of humidity in the vehicle interior, and removal of harmful volatile components such as odor components and allergy-causing components in the vehicle interior. The effective measure for such requirements includes ventilation, but the ventilation causes a large loss of heater energy in winter, leading to a decreased energy efficiency in winter. In particular, a battery electric vehicle (BEV) has a problem that its cruising range is significantly reduced due to its energy loss.

As a method for solving the above problems, Patent Literature 1 proposes a heater element comprising: a honeycomb structure having an outer peripheral wall and partition walls disposed on an inner side of the outer peripheral wall, the partition walls defining a plurality of cells each extending from one end face to other end face to form a flow path, at least the partition walls having a material having a PTC (Positive Temperature Coefficient) property; and a pair of electrodes provided on certain positions of the honeycomb structure, wherein the heater element has an adsorbing layer (a functional material-containing layer) for adsorbing water vapor, CO₂ and the like on surfaces of the partition walls.

When the humidity in a vehicle interior is high, the moisture adsorbed on the adsorbing layer is easily saturated, so that an adsorption process must be repeated after the adsorbing layer is regenerated. In order to efficiently dehumidify the vehicle interior at this time, a smooth transition from the regeneration process to the adsorption process is important.

However, only using the heater element of Patent Literature 1, the adsorbing layer heated during the regeneration process is difficult to cool down, so that it takes a long period of time to transfer to the adsorption process.

The present invention was made to solve the problems as described above. An object of the present invention is to provide an air conditioning system for vehicles and a method for using an air conditioning device that are capable of a smooth transition from the regeneration process to the adsorption process.

### PRIOR ART

### Patent Literature

[Patent Literature 1] WO 2023/074202 A1

### SUMMARY OF THE INVENTION

As a result of intensive studies for vehicle air conditioning systems including air conditioning devices, the present inventors have found that, at the end period of the regeneration process of the adsorbing layer and/or during the adsorption process after the regeneration process, a flow velocity of air when the adsorbing layer is above the adsorption temperature can be controlled to be higher than that of the air when the adsorbing layer is below the adsorption temperature, thereby allowing the adsorbing layer to be rapidly cooled to a temperature at which the adsorption capacity of the adsorbent can be exerted, and enabling the smooth transition from the regeneration process to the adsorption process, and they have completed the present invention. In other words, the invention is exemplified as follows:

<1> A vehicle air conditioning system, comprising:
an air conditioning duct through which air can flow;
   an air conditioning device comprising: a honeycomb structure having an outer peripheral wall and partition walls disposed on an inner side of the outer peripheral wall, the partition walls defining a plurality of cells, each of the cells extending from a first end face to a second end face to form a flow path for the air; and an adsorbing layer containing an adsorbent, the adsorbing layer being provided on each surface of the partition walls, the air conditioning device being disposed in the air conditioning duct; and
   a control unit capable of controlling a flow velocity of the air flowing through the cells of the air conditioning device,
wherein, at an end period of a regeneration process of the adsorbing layer and/or during an adsorption process after a regeneration process, the control unit controls the flow velocity of the air when the adsorbing layer is above an adsorption temperature to be higher than that of the air when the adsorbing layer is below the adsorption temperature.

<2> The vehicle air conditioning system according to <1>, wherein the control of the flow velocity of the air is performed within 15 seconds from the end of the regeneration process.

<3> The vehicle air conditioning system according to <1>, wherein the end period of the regeneration process is a period during the regeneration process within ¼ of a regeneration process time from the end of the regeneration process.

<4> The vehicle air conditioning system according to any one of <1> to <3>, wherein the regeneration process and the adsorption process are repeated.

<5> The vehicle air conditioning system according to any one of <1> to <4>, wherein a ratio of the flow velocity of the air when the adsorbing layer is above the adsorption temperature to the flow velocity of the air when the adsorbing layer is below the adsorption temperature is 1.1 or more.

<6> The vehicle air conditioning system according to any one of <1> to <5>, wherein the flow velocity of the air when the adsorbing layer is above the adsorption temperature is 0.03 m/s or more.

<7> The vehicle air conditioning system according to any one of <1> to <6>, wherein a temperature of the adsorbing layer is obtained by previously determining a relationship between at least one condition parameter and a temperature of the adsorbing layer, the at least one condition parameter being selected from a temperature of the honeycomb structure, a resistance value of the honeycomb structure, a current value of the honeycomb structure, a heating time of the honeycomb structure, a temperature of the air passing through the honeycomb structure, and amounts of components contained in the air passing through the honeycomb structure, and then measuring the condition parameter.

<8> The vehicle air conditioning system according to any one of <1> to <7>, further comprising a ventilation fan disposed in the air conditioning duct, wherein the control unit controls the flow velocity of the air by adjusting a rotation speed of the ventilation fan.

<9> The vehicle air conditioning system according to any one of <1> to <8>, wherein the air conditioning duct is, on a downstream side, branched into a first flow path for allowing the air to flow into the vehicle interior and a second flow path for discharging the air to a vehicle exterior, and wherein the air conditioning duct further comprises a valve capable of switching the flow of the air between the first flow path and the second flow path.

<10> The vehicle air conditioning system according to <9>, further comprising a power source for applying voltage to the air conditioning device.

<11> The vehicle air conditioning system according to <10>, wherein the control unit can perform:
an adsorption process for turning off an applied voltage from the power source and switching the valve so that the air flowing through the air conditioning duct passes through the first flow path; and
a regeneration process for turning on the applied voltage from the power source and switching the valve so that the air flowing through the air conditioning duct passes through the second flow path.

<12> The vehicle air conditioning system according to any one of <1> to <11>, wherein at least the partition walls of the honeycomb structure are made of a material having a PTC property.

<13> The vehicle air conditioning system according to any one of <1> to <12>, wherein the air conditioning device further comprises a pair of electrodes provided on the first end face and the second end face of the honeycomb structure, or on the outer peripheral wall parallel to an extending direction of the cells of the honeycomb structure.

<14> The vehicle air conditioning system according to any one of <1> to <13>, wherein the adsorbent is capable of adsorbing at least one of moisture, carbon dioxide and volatile components.

<15> A method for using an air conditioning device, the air conditioning device comprising: a honeycomb structure having an outer peripheral wall and partition walls disposed on an inner side of the outer peripheral wall, the partition walls defining a plurality of cells, each of the cells extending from a first end face to a second end face to form a flow path for air; and an adsorbing layer containing an adsorbent, the adsorbing layer being provided on each surface of the partition walls, the method comprising:
at an end period of a regeneration process of the adsorbing layer and/or during an adsorption process after the regeneration process, controlling a flow velocity of the air when the adsorbing layer is above an adsorption temperature to be higher than that of the air when the adsorbing layer is below the adsorption temperature.

<16> The method for using the air conditioning device according to <15>, wherein controlling the flow velocity of the air is performed within 15 seconds from the end of the regeneration process.

<17> The method for using the air conditioning device according to <15>, wherein the end period of the regeneration process is a period during the regeneration process within ¼ of a regeneration process time from the end of the regeneration process.

<18> The method for using the air conditioning device according to any one of <15> to <17>, wherein the regeneration process and the adsorption process are repeated.

<19> The method for using the air conditioning device according to any one of <15> to <18>, wherein a ratio of the flow velocity of the air when the adsorbing layer is above the adsorption temperature to the flow velocity of the air when the adsorbing layer is below the adsorption temperature is 1.1 or more.

<20> The method for using the air conditioning device according to any one of <15> to <19>, wherein the flow velocity of the air when the adsorbing layer is above the adsorption temperature is 0.03 m/s or more.

<21> The method for using the air conditioning device according to any one of <15> to <20>, wherein at least the partition walls of the honeycomb structure are made of a material having a PTC property.

<22> The method for using the air conditioning device according to any one of <15> to <21>, wherein the air conditioning device further comprises a pair of electrodes provided on the first end face and the second end face of the honeycomb structure, or on the outer peripheral wall parallel to an extending direction of the cells of the honeycomb structure.

<23> The method for using the air conditioning device according to any one of [15] to [22], wherein the adsorbent is capable of adsorbing at least one of moisture, carbon dioxide and volatile components.

### BRIEF DESCRIPTION OF THE DRAWINGS

FIG. 1 is an overall schematic configuration view of a vehicle air conditioning system according to an embodiment of the present invention;

FIG. 2A is a schematic view of a cross section of an air conditioning device used in a vehicle air conditioning system according to an embodiment of the present invention, which is parallel to a flow path direction;

FIG. 2B is a schematic cross-sectional view of the air conditioning device in FIG. 2A taken along the line a-a′;

FIG. 3A is a graph showing a temperature of an adsorbing layer, a flow velocity of air, and a presence or absence of an applied voltage to a honeycomb structure when a flow velocity of the air is controlled during an adsorption process after a regeneration process of the adsorbing layer;

FIG. 3B is a graph showing a temperature of an adsorbing layer, a flow velocity of air, and a presence or absence of an applied voltage to a honeycomb structure when the flow velocity of the air is controlled at an end period of a regeneration process of the adsorbing layer;

FIG. 3C is a graph showing a temperature of an adsorbing layer, a flow velocity of air, and a presence or absence of an applied voltage to a honeycomb structure when a flow velocity of the air is controlled at an end period of a regeneration process of the adsorbing layer and during an adsorption process after the regeneration process; and

FIG. 3D is a graph showing a temperature of an adsorbing layer, a flow velocity of air, and a presence or absence of an applied voltage to a honeycomb structure when a flow velocity of the air is not changed in a conventional method.

### DETAILED DESCRIPTION OF THE INVENTION

A vehicle air conditioning system according to the present invention includes: an air conditioning duct through which air can flow; an air conditioning device including: a honeycomb structure having an outer peripheral wall and partition walls disposed on an inner side of the outer peripheral wall, the partition walls defining a plurality of cells, each of the cells extending from a first end face to a second end face to form a flow path for the air; and an adsorbing layer containing an adsorbent, the adsorbing layer being provided on each surface of the partition walls, the air conditioning device being disposed in the air conditioning duct; and a control unit capable of controlling a flow velocity of the air flowing through the cells of the air conditioning device. At an end period of a regeneration process of the adsorbing layer and/or during an adsorption process after a regeneration process, the control unit controls the flow velocity of the air when the adsorbing layer is above an adsorption temperature to be higher than that of the air when the adsorbing layer is below the adsorption temperature. This configuration of the vehicle air conditioning system allows the adsorbing layer to be rapidly cooled to a temperature at which an adsorption capacity of the adsorbent can be exerted, and enables a smooth transition from the regeneration process to the adsorption process. This allows the humidity in the vehicle interior to be reduced efficiently.

Also, in an air conditioning device including: a honeycomb structure having an outer peripheral wall and partition walls disposed on an inner side of the outer peripheral wall, the partition walls defining a plurality of cells, each of the cells extending from a first end face to a second end face to form a flow path for air; and an adsorbing layer containing an adsorbent, the adsorbing layer being provided on each surface of the partition walls, a method for using the air conditioning device according to the present invention controls a flow velocity of the air when the adsorbing layer is above an adsorption temperature to be higher than that of the air when the adsorbing layer is below the adsorption temperature at an end period of a regeneration process of the adsorbing layer and/or during an adsorption process after the regeneration process. This configuration of the method for using the air conditioning device allows the adsorbing layer to be rapidly cooled to a temperature at which an adsorption capacity of the adsorbent can be exerted and enables a smooth transition from the regeneration process to the adsorption process. This allows the humidity in the vehicle to be reduced efficiently.

Hereinafter, embodiments of the present invention will be specifically described with reference to the drawings. It is to understand that the present invention is not limited to the following embodiments, and those which have appropriately added changes, improvements and the like to the following embodiments based on knowledge of a person skilled in the art without departing from the spirit of the present invention fall within the scope of the present invention.

### Vehicle Air Conditioning System

The vehicle air conditioning system according to an embodiment of the present invention can be suitably utilized for various vehicles such as automobiles. The vehicle includes, but not limited to, automobiles and electric rail cars. Non-limiting examples of the automobile include a gasoline vehicle, a diesel vehicle, a gas fuel vehicle using CNG (a compressed natural gas) or LNG (a liquefied natural gas), a fuel cell vehicle, an electric vehicle, and a plug-in hybrid vehicle. The vehicle air conditioning system according to the embodiment of the present invention can be particularly suitably used for a vehicle having no internal combustion engine such as electric vehicles and electric railcars.

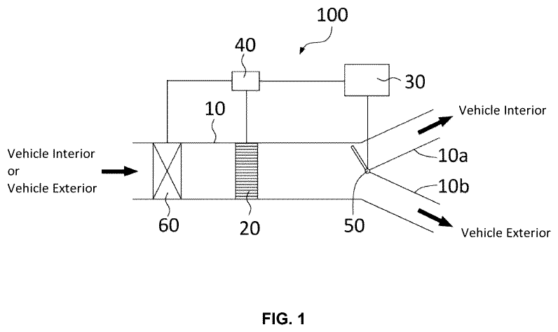

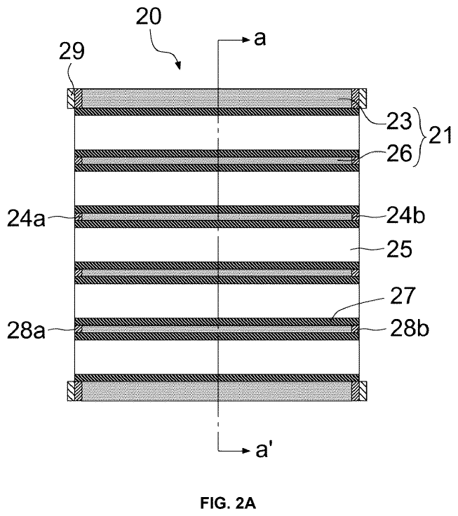

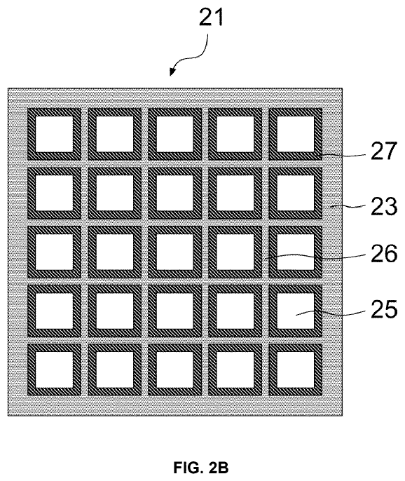

FIG. 1 is an overall schematic configuration view of a vehicle air conditioning system according to an embodiment of the present invention. FIG. 2A is a schematic view of a cross section of an air conditioning device used in a vehicle air conditioning system according to an embodiment of the present invention, which is parallel to a flow path direction. FIG. 2B is a schematic cross-sectional view of the air conditioning device in FIG. 2A taken along the line a-a′.

As shown in FIG. 1, a vehicle air conditioning system 100 according to an embodiment of the present invention includes: an air conditioning duct 10; an air conditioning device 20; and a control unit 30. Further, the vehicle air conditioning system 100 can further include: a power source 40; a valve 50; and a ventilation fan 60.

The air conditioning duct 10 is a pipe through which air can flow from the vehicle interior or the vehicle exterior. The air conditioning duct 10 can have, on a downstream side of the air conditioning device 20, a first flow path 10a that allows the air to flow into the vehicle interior, and a second flow path 10b that allows the air to be discharged to the vehicle exterior.

The air conditioning device 20 is disposed in the air conditioning duct 10. The number of air conditioning devices 20 disposed in the air conditioning duct 10 may be one or more. When multiple air conditioning devices 20 are provided, they may be arranged in parallel or in series with respect to the flow of the air flowing through the air conditioning duct 10.

As shown in FIGS. 2A and 2B, the air conditioning device 20 includes: a honeycomb structure 21 having an outer peripheral wall 23 and partition walls 26 disposed on an inner side of the outer peripheral wall 23, the partition walls 26 defining a plurality of cells 25 each extending from a first end face 24a to a second end face 24b to form a flow path for air; and an adsorbing layer 27 formed on a surface of each of the partition wall 26. The honeycomb structure 21 can further include: a pair of electrodes 28a, 28b; and terminals 29 connected to the pair of electrodes 28a, 28b.

The control unit 30 can also control the flow velocity of the air flowing through the cells 25 of the air conditioning device 20. Specifically, the control unit 30 controls the flow velocity (flow rate) of the air by adjusting the rotation speed of the ventilation fan 60 electrically connected to the control unit 30. Also, the control unit 30 is electrically connected to a power source 40, a valve 50, and the like, and it can control these members.

In the vehicle air conditioning system 100 having the above structure, air from the vehicle interior or vehicle exterior flows into the air conditioning device 20 through the air conditioning duct 10, in the adsorption process and the regeneration process of the air conditioning device 20. In the adsorption process of the air conditioning device 20 (adsorbing layer 27), moisture and CO₂ in the air are captured (adsorbed) by the adsorbing layer 27 of the air conditioning device 20, and the air with reduced moisture and CO₂ flows into the vehicle interior through first flow path 10a. On the other hand, in the regeneration process of the air conditioning device 20 (adsorbing layer 27), the moisture, CO₂ and the like trapped in the adsorbing layer 27 are separated as the honeycomb structure 21 of the air conditioning device 20 is heated, and the air containing moisture, CO₂ and the like flows out to the vehicle exterior through the second flow path 10b.

At the end period of the regeneration process of the adsorbing layer 27 and/or during the adsorption process after the regeneration process, the control unit 30 controls the flow velocity of the air when the adsorbing layer 27 is above the adsorption temperature to be higher than that of the air when the adsorbing layer 27 is below the adsorption temperature.

When the adsorbing layer 27 is above the adsorption temperature, the adsorbing layer 27 will not adsorb the moisture, CO₂ and the like, and so it is desirable to cool the adsorbing layer 27 as rapidly as possible so that the adsorbing layer 27 is below the adsorption temperature. Therefore, when the adsorbing layer 27 is above the adsorption temperature, the flow velocity of the air is rapidly increased to facilitate the cooling of the adsorbing layer 27.

By controlling the flow velocity of the air at the end period of the regeneration process of the adsorbing layer 27 and/or during the adsorption process after the regeneration process, a smooth transition from the regeneration process to the adsorption process can be achieved.

As used herein, the “adsorption temperature” refers to a temperature at which the adsorbent contained in the adsorbing layer 27 can exert its adsorption capacity. Therefore, the adsorption temperature is determined depending on the type of adsorbent and the type of major component to be adsorbed. For example, if the main component to be adsorbed is moisture, the adsorption temperature is the temperature at which the moisture can be adsorbed. A typical adsorption temperature in this case is from 0 to 60° C.

As used herein, the “regeneration process” means a process for allowing the air to flow through the cells 25 while heating the honeycomb structure 21 (i.e., while applying voltage), and the “adsorption process” means a process for allowing the air to flow through the cells 25 without heating the honeycomb structure 21 (i.e., without applying voltage).

As used herein, the “end period of the regeneration process” means a period near the end of the regeneration process. The end period of the regeneration process is not particularly limited, but it is preferably a period during the regeneration process within ¼ of the regeneration processing time from the end of the regeneration process, and more preferably a period during the regeneration process within ⅛ of the regeneration processing time from the end of the regeneration process, and further preferably a period during the regeneration process within 1/10 of the regeneration processing time from the end of the regeneration process.

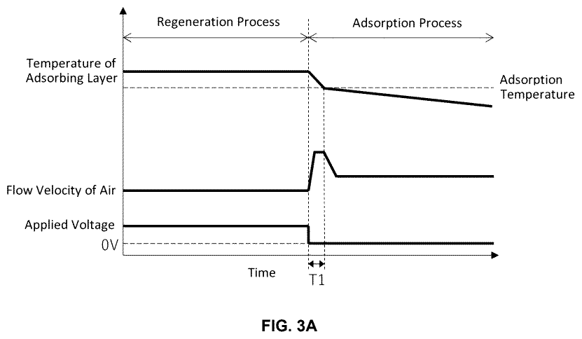

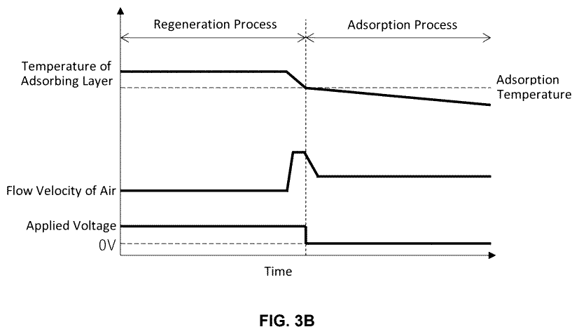

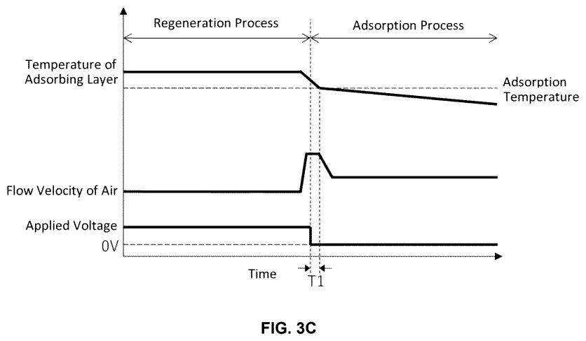

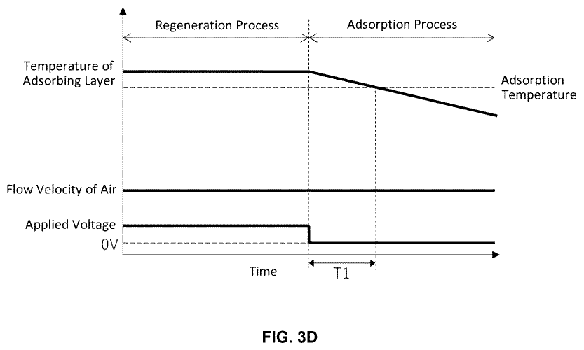

FIG. 3A shows the temperature of the adsorbing layer 27, the flow velocity of the air, and the presence or absence of the applied voltage to the honeycomb structure 21 when the above control is performed during the adsorption process after the regeneration process of the adsorbing layer 27.

FIG. 3B shows the temperature of the adsorbing layer 27, the flow velocity of the air, and the presence or absence of the applied voltage to the honeycomb structure 21 when the above control is performed at the end period of the regeneration process of the adsorbing layer 27.

FIG. 3C shows the temperature of the adsorbing layer 27, the flow velocity of the air, and the presence or absence of the applied voltage to the honeycomb structure 21 when the above control is performed at the end period of the regeneration process of the adsorbing layer 27 and during adsorption after the regeneration process.

FIG. 3D shows the temperature of the adsorbing layer 27, the flow velocity of the air, and the presence or absence of the applied voltage to the honeycomb structure 21 when the above control is not performed (conventional method that does not change the flow velocity of the air).

As shown in FIGS. 3A to 3D, as compared to the conventional methods that do not change the flow velocity of the air, the above control at the end period of the regeneration process of the adsorbing layer 27 and/or during the adsorption process after the regeneration process can shorten a time T1 from the end of the regeneration process to a point where adsorption becomes possible in the adsorption process, so that this enables a smooth transition from the regeneration process to the adsorption process. In particular, from the viewpoint of shortening the time T1 from the end of the regeneration process to the point where adsorption becomes possible in the adsorption process, it is preferable to perform the above control at the end period of the regeneration process of the adsorbing layer 27 or at the end period of the regeneration process of the adsorbing layer 27 and during the adsorption process after the regeneration process. From the viewpoint of reducing the waste of power consumption, it is preferable to perform the above control during the adsorption process after the regeneration process of the adsorbing layer 27.

The above control is preferably performed within 15 seconds from the end of the regeneration process. Specifically, when the above control is performed during the adsorption process after the regeneration process of the adsorbing layer 27 or at the end period of the regeneration process of the adsorbing layer 27 and during the adsorption process after the regeneration process, the above control is preferably completed within 15 seconds from the end of the regeneration process. Such a control allows the adsorption process to be rapidly started. Also, as the flow velocity of the air is increased, noise is more likely to occur due to the increased rotation speed of the ventilation fan 60. However, by performing the above control within 15 seconds from the end of the regeneration process, the period during which noise is likely to occur can be shortened.

The regeneration process and the adsorption process can be performed as needed depending on the humidity in the vehicle interior, but if the humidity in the vehicle interior is higher, the regeneration process and the adsorption processes are preferably repeated. By repeating the regeneration process and the adsorption process, even if the moisture adsorbed on the adsorbing layer 27 is saturated, the moisture adsorbed on the adsorbing layer 27 can be separated by the regeneration process, and the moisture can be adsorbed immediately thereafter by the adsorption process, thus efficiently reducing the humidity in the vehicle interior.

From the viewpoint of efficient cooling of the adsorbing layer 27, the ratio of the flow velocity of the air when the adsorbing layer 27 is above the adsorption temperature to the flow velocity of the air when the adsorbing layer 27 is below the adsorption temperature is preferably 1.1 or more, and more preferably 1.2 or more, and even more preferably 1.3 or more.

The upper limit of the ratio of the flow velocity of the air when the adsorbing layer 27 is above the adsorption temperature to the flow velocity of the air when the adsorbing layer 27 is below the adsorption temperature is not particularly limited, but from the viewpoint of suppressing noise due to an increase in the rotation speed of the ventilation fan 60, it is preferably 4.0 or less, and more preferably 3.5 or less, and further preferably 3.0 or less.

The flow velocity of the air when the adsorbing layer 27 is above the adsorption temperature is not particularly limited as long as the above conditions are fulfilled, but it is preferably 0.02 m/s or more, and more preferably 0.025 m/s or more, and even more preferably 0.03 m/s or more. Such a control to the flow velocity of the air allows the cooling of the adsorbing layer 27 to be efficiently carried out.

The flow velocity of the air when the adsorbing layer 27 is above the adsorption temperature is preferably 3.00 m/s or less, and more preferably 2.80 m/s or less, and even more preferably 2.50 m/s or less. Such a control can suppress the noise caused by the increased speed of the ventilation fan 60.

The flow velocity of the air when the adsorbing layer 27 is below the adsorption temperature is not limited as long as the above conditions are fulfilled, but it is preferably 0.01 to 1.00 m/s, and more preferably 0.02 to 0.93 m/s, and more preferably 0.03 to 0.83 m/s.

The temperature of the adsorbing layer 27 is preferably obtained by previously determining a relationship between at least one condition parameter and a temperature of the adsorbing layer 27, the at least one condition parameter being selected from the temperature of the honeycomb structure 21, the resistance value of the honeycomb structure 21, the current value of the honeycomb structure 21, the heating time of the honeycomb structure 21, the temperature of the air passing through the honeycomb structure 21, and the amount of the components contained in the air passing through the honeycomb structure 21, and then measuring the condition parameter. Although it is difficult to directly measure the temperature of the adsorbing layer 27 in the vehicle air conditioning system 100, the temperature of the adsorbing layer 27 can be determined by measuring the condition parameter as described above.

Each component of the vehicle air conditioning system 100 will be described below in detail.

### 1. Air Conditioning Duct 10

The air conditioning duct 10 is a flow path through which air can flow. The upstream side of the air conditioning duct 10 is connected to the vehicle interior or an outside air introduction port. The air conditioning duct 10 allows the air from the vehicle interior or vehicle exterior to flow in, and also allows the air that has passed through the air conditioning device 20 to flow in the vehicle interior or flow out to the vehicle exterior. Therefore, on a downstream side of the air conditioning device 20, the air conditioning duct 10 is preferably branched into the first flow path 10a that allows the air to flow into the vehicle interior, and the second flow path 10b that allows the air to be discharged to the vehicle exterior.

The air conditioning duct 10 may include a valve 50 that can switch the flow of the air between the first flow path 10a and the second flow path 10b. The valve 50 is not particularly limited as long as it is electrically driven and has the function of switching the flow path, and a solenoid valve, an electric valve, and the like can be used. For example, the valve 50 includes an opening/closing door supported by a rotating shaft and an actuator such as a motor that rotates the rotating shaft. The actuator can be configured to be controllable by the control unit 30.

### 2. Air Conditioning Device 20

2-1. Honeycomb Structure 21

The shape of the honeycomb structure 21 is not particularly limited. For example, an outer shape of a cross section of the honeycomb structure 21 orthogonal to the flow path direction (the extending direction of the cells 25) can be polygonal such as quadrangular (rectangular, square), pentagonal, hexagonal, heptagonal, and octagonal, circular, oval (egg-shaped, elliptical, elliptic, rounded rectangular, etc.), or the like. The end faces (first end face 24a and second end face 24b) have the same shape as the cross section. Also, when the cross section and the end faces are polygonal, the corners may be chamfered.

The shape of each cell 25 is not particularly limited, but it may be polygonal such as quadrangular, pentagonal, hexagonal, heptagonal, and octagonal, circular, or oval in the cross section of the honeycomb structure 21 orthogonal to the flow path direction. These shapes may be alone or in combination of two or more.

Moreover, among these shapes, the quadrangle or the hexagon is preferable. By providing the cells 25 having such a shape, it is possible to reduce the pressure loss when the air flows.

The honeycomb structure 21 may be a honeycomb joined body having a plurality of honeycomb segments and joining layers that join outer peripheral side surfaces of the plurality of honeycomb segments together. The use of the honeycomb joined body can increase the total cross-sectional area of the cells 25, which is important for ensuring the flow rate (flow velocity) of the air, while suppressing cracking.

It should be noted that the joining layer can be formed by using a joining material. The joining material is not particularly limited, but a ceramic material obtained by adding a solvent such as water to form a paste can be used. The joining material may contain a material having the PTC property, or may contain the same material as the outer peripheral wall 23 and the partition walls 26. In addition to the role of joining the honeycomb segments to each other, the joining material can also be used as an outer peripheral coating material after joining the honeycomb segments.

From the viewpoints of ensuring the strength of the honeycomb structure 21, reducing pressure loss when air passes through the cells 25, ensuring the amount of functional material supported, and ensuring the contact area with the air flowing inside the cells 25, it is desirable to suitably combine a thickness of the partition wall 26, a cell density, and a cell pitch (or an opening ratio of the cells 25).

As used herein, the cell density refers a value obtained by dividing a number of cells by an area of one end face (first end face 24a or second end face 24b) of the honeycomb structure 21 (the total area of the partition walls 26 and the cells 25 excluding the outer peripheral wall 23).

As used herein, the cell pitch refers to a value obtained by the following calculation. First, the area of one end face (first end face 24a or second end face 24b) of the honeycomb structure 21 (the total area of the partition walls 26 and the cells 25 excluding the outer peripheral wall 23) is divided by the number of the cells to calculate an area per a cell. A square root of the area per a cell is then calculated, and this is determined to be the cell pitch.

As used herein, the opening ratio of the cells 25 refers a value obtained by dividing the total area of the cells 25 defined by the partition walls 26 by the area of one end face (first end face 24a or second end face 24b) (the total area of the partition walls 26 and the cells 25 excluding the outer peripheral wall 23) in the cross section orthogonal to the flow path direction of the honeycomb structure 21. It should be noted that when calculating the opening ratio of the cells 25, the pair of electrodes 28a, 28b, and the adsorbing layer 27 are not taken into account.

In an embodiment that is advantageous from the viewpoint of supporting a sufficient amount of functional material, the thickness of the partition walls 26 is 0.300 mm or less, the cell density is 100 cells/cm² or less, and the cell pitch is 1.0 mm or more. In a preferred embodiment, the thickness of the partition walls 26 is 0.200 mm or less, the cell density is 70 cells/cm² or less, and the cell pitch is 1.2 mm or more. In a more preferred embodiment, the thickness of the partition walls 26 is 0.130 mm or less, the cell density is 65 cells/cm² or less, and the cell pitch is 1.3 mm or more.

From the viewpoints of ensuring the strength of the honeycomb structure 21 and maintaining lower electrical resistance, the lower limit of the thickness of the partition wall 26 is preferably 0.010 mm or more, and more preferably 0.020 mm or more, and even more preferably 0.030 mm or more.

From the viewpoints of ensuring the strength of the honeycomb structure 21, maintaining lower electrical resistance, and increasing a surface area to facilitate reaction, adsorption, and release, the lower limit of the cell density is 30 cells/cm² or more, and preferably 35 cells/cm² or more, and even more preferably 40 cells/cm² or more.

From the viewpoints of ensuring the strength of the honeycomb structure 21, maintaining lower electrical resistance and increasing a surface area to facilitate reaction, adsorption and release, the upper limit of the cell pitch is 2.0 mm or less, and more preferably 1.8 mm or less, and even more preferably 1.6 mm or less.

In an embodiment that is advantageous in terms of both reducing pressure loss and maintaining strength, the thickness of the partition walls 26 is 0.08 to 0.36 mm, the cell density is 2.54 to 140 cells/cm², and the opening ratio of the cells 25 is 0.70 or more. In a preferred embodiment, the thickness of the partition walls 26 is 0.09 to 0.35 mm, the cell density is 15 to 100 cells/cm², and the opening ratio of the cells 25 is 0.80 or more. In a more preferred embodiment, the thickness of the partition walls 26 is 0.14 to 0.30 mm, the cell density is 20 to 90 cells/cm², and the opening ratio of the cells 25 is 0.85 or more.

From the viewpoint of ensuring the strength of the honeycomb structure 21, the upper limit of the opening ratio of the cells 25 is preferably 0.94 or less, and more preferably 0.92 or less, and even more preferably 0.90 or less.

Although the thickness of the outer peripheral wall 23 is not particularly limited, it is preferably determined based on the following viewpoints. First, from the viewpoint of reinforcing the honeycomb structure 21, the thickness of the outer peripheral wall 23 is preferably 0.05 mm or more, and more preferably 0.06 mm or more, and even more preferably 0.08 mm or more. On the other hand, the thickness of the outer peripheral wall 23 is preferably 1.0 mm or less, and more preferably 0.5 mm, and more preferably 0.4 mm or less, and still more preferably 0.3 mm or less, from the viewpoint of suppressing the initial current by increasing the electrical resistance and from the viewpoint of reducing pressure loss when air flows.

As used herein, the thickness of the outer peripheral wall 23 refers to a length from a boundary between the outer peripheral wall 23 and the outermost cell 25 or the partition wall 26 to a side surface of the honeycomb structure 21 in a normal line direction of the side surface in the cross section orthogonal to the flow path direction.

The length of the honeycomb structure 21 in the flow path direction and the cross-sectional area orthogonal to the flow path direction may be adjusted according to the required size of the air conditioning device 20, and are not particularly limited. For example, when used in a compact air conditioning device 20 while ensuring a predetermined function, the honeycomb structure 21 can have a length of 2 to 20 mm in the flow path direction and a cross-sectional area of 10 cm² or more orthogonal to the flow path direction. Although the upper limit of the cross-sectional area orthogonal to the flow path direction is not particularly limited, it is, for example, 300 cm² or less.

The partition walls 26 forming the honeycomb structure 21 are preferably made of a material that can be heated by electric conduction, specifically made of a material having the PTC property. Further, the outer peripheral wall 23 may also be made of the material having the PTC property, as with the partition walls 26, as needed. By such a configuration, the adsorbing layer 27 can be directly heated by heat transfer from the heat-generating partition walls 26 (and optionally the outer peripheral wall 23). Further, the material having the PTC property has characteristics such that when the temperature increases to exceed the Curie point, the resistance value is sharply increased, resulting in a difficult for electricity to flow. Therefore, when the temperature of the partition walls 26 (and the outer peripheral wall 23 if necessary) becomes high, the current flowing through them is limited, thereby suppressing excessive heat generation of the honeycomb structure 21.

Therefore, it is possible to suppress thermal deterioration of the adsorbing layer 27 due to excessive heat generation.

The lower limit of the volume resistivity at 25° C. of the material having the PTC property is preferably 0.5 Ω·cm or more, and more preferably 1 Ω·cm or more, and even more preferably 5 Ω·cm or more, from the viewpoint of obtaining appropriate heat generation. The upper limit of the volume resistivity at 25° C. of the material having the PTC property is preferably 30 Ω·cm or less, and more preferably 18 Ω·cm or less, and even more preferably 16 Ω·cm or less, from the viewpoint of generating heat with a low driving voltage. As used herein, the volume resistivity at 25° C. of the material having the PTC property is measured according to JIS K 6271:2008.

From the viewpoints that can be heated by electric conduction and has the PTC property, the outer peripheral wall 23 and the partition walls 26 are preferably made of a material containing barium titanate (BaTiO₃) as a main component. Also, this material is more preferably ceramics made of a material containing barium titanate (BaTiO₃)-based crystals as a main component in which a part of Ba is substituted with a rare earth element. As used herein, the term “main component” means a component in which a proportion of the component is more than 50% by mass of the total component. The content of BaTiO₃-based crystalline particles can be determined by fluorescent X-ray analysis. Other crystalline particles can be measured in the same manner as this method.

The compositional formula of BaTiO₃-based crystalline particles, in which a part of Ba is substituted with the rare earth element, can be expressed as (Ba₁₋ₓAₓ)TiO₃. In the compositional formula, the symbol A represents at least one rare earth element, and 0.001≤x≤0.010.

The symbol A is not particularly limited as long as it is the rare earth element, but it may preferably be one or more selected from the group consisting of La, Ce, Pr, Nd, Eu, Gd, Dy, Ho, Er, Y and Yb, and more preferably La. The x value is preferably 0.001 or more, and more preferably 0.0015 or more, in terms of suppressing excessively high electrical resistance at room temperature. On the other hand, x is preferably 0.009 or less, in terms of preventing the electrical resistance at room temperature from becoming too high due to insufficient sintering. The content of the BaTiO₃-based crystalline particles in which a part of Ba is substituted with the rare earth element in the ceramics is not particularly limited as long as it is determined to be the main component, but it may preferably be 90% by mass or more, and more preferably 92% by mass or more, and even more preferably 94% by mass or more. The upper limit of the content of the BaTiO₃-based crystalline particles is not particularly limited, but it may generally be 99% by mass, and preferably 98% by mass.

In terms of reduction of the environmental load, it is desirable that the materials used for the outer peripheral wall 23 and the partition walls 26 are substantially free of lead (Pb). More particularly, the outer peripheral wall 23 and the partition walls 26 preferably have a Pb content of 0.01% by mass or less, and more preferably 0.001% by mass or less, and still more preferably 0% by mass.

The lower Pb content can allow the air heated by contact with the heat-generating partition walls 26 to be safely applied to organisms such as humans, for example. In the outer peripheral wall 23 and the partition walls 26, the Pb content is preferably less than 0.03% by mass, and more preferably less than 0.01% by mass, and further preferably 0% by mass, as converted to PbO. The lead content can be determined by ICP-MS (inductively coupled plasma mass spectrometry).

The Curie point of the material making up the outer peripheral wall 23 and the partition walls 26 is preferably in a temperature range where the resistance value is twice or more the resistance at room temperature (25° C.). If the Curie point is in such a temperature range, the current flowing through the air conditioning device 20 will be limited when the temperature of the air conditioning device 20 becomes high, so that any excessive heat generation of the air conditioning device 20 will be efficiently suppressed. Therefore, thermal deterioration of the adsorbing layer 27 caused by excessive heat generation can be suppressed.

The material making up the outer peripheral wall 23 and the partition walls 26 preferably have a lower limit of a Curie point of 80° C. or more, and more preferably 100° C. or more, and even more preferably 110° C. or more, and still more preferably 125° C. or more, in terms of efficiently heating the adsorbing layer 27. Further, the upper limit of the Curie point is preferably 200° C. or more, and preferably 190° C. or more, and even more preferably 180° C. or more, and particularly preferably 150° C. or more, in terms of safety as a component placed in the vehicle interior or near the vehicle interior.

The Curie point of the material making up the outer peripheral wall 23 and the partition walls 26 can be adjusted by the type of shifter and an amount of the shifter added. For example, the Curie point of barium titanate (BaTIO₃) is about 120° C., but the Curie point can be shifted to the lower temperature side by substituting a part of Ba and Ti with one or more of Sr, Sn and Zr.

As used herein, the Curie point is measured by the following method. A sample is attached to a sample holder for measurement, mounted in a measuring tank (e.g., MINI-SUBZERO MC-810P, from ESPEC), and a change in electrical resistance of the sample as a function of a temperature change when the temperature is increased from 10° C. is measured using a DC resistance meter (e.g., Multimeter 3478A, from JAPAN HEWLETT PACKARD, LLC). Based on an electrical resistance-temperature plot obtained by the measurement, a temperature at which the resistance value is twice the resistance value at room temperature (25° C.) is defined as the Curie point.

### 2-2. Pair of Electrodes 28a, 28b

A pair of electrodes 28a, 28b may be provided on the first end face 24a and the second end face 24b as shown in FIG. 2A, although the positions of the electrodes 28a, 28b are not limited thereto. Also, the pair of electrodes 28a, 28b may be provided on the outer peripheral wall 23 parallel to the extending direction of the cells 25 of the honeycomb structure 21.

Applying of a voltage between the pair of electrodes 28a, 28b allows the honeycomb structure 21 to generate heat by Joule heat.

The pair of electrodes 28a, 28b may employ, for example, a metal or alloy containing at least one selected from Cu, Ag, Al, Ni and Si, although not particularly limited thereto. It is also possible to use an ohmic electrode capable of ohmic contact with the outer peripheral wall 23 and/or the partition walls 26 which have the PTC property. The ohmic electrode may employ an ohmic electrode containing, for example, at least one selected from Al, Au, Ag and In as a base metal, and containing at least one selected from Ni, Si, Zn, Ge, Sn, Se and Te for n-type semiconductors as a dopant. Further, the pair of electrodes 28a, 28b may have a single-layer structure, or may have a laminated structure of two or more layers.

When the pair of electrodes 28a, 28b have the laminated structure of two or more layers, the materials of the respective layers may be of the same type or of different types.

The thickness of the pair of electrodes 28a, 28b may be appropriately set according to the method for forming the pair of electrodes 28a, 28b. The method for forming the pair of electrodes 28a, 28b includes metal deposition methods such as sputtering, vapor deposition, electrolytic deposition, and chemical deposition.

Alternatively, the pair of electrodes 28a, 28b can be formed by applying an electrode paste and then baking it, or by thermal spraying. Furthermore, the pair of electrodes 28a, 28b may be formed by joining metal sheets or alloy sheets.

Each of the thicknesses of the pair of electrodes 28a, 28b is, for example, about 5 to 80 μm for baking the electrode paste, and about 100 to 1000 nm for dry plating such as sputtering and vapor deposition, and about 10 to 100 μm for thermal spraying, and about 5 μm to 30 μm for wet plating such as electrolytic deposition and chemical deposition. Further, when joining the metal sheet or alloy sheet, each of the thicknesses is preferably about 5 to 100 μm.

### 2-3. Terminal 29

The terminals 29 are connected to the pair of electrodes 28a, 28b, and provided on at least part of the pair of electrodes 28a, 28b. The provision of the terminals 29 facilitates connection to an external power supply. The terminals 29 are connected to a conductor connected to the external power supply.

The terminals 29 may be made of any material, including, but not particularly limited to, a metal, for example. The metal that can be used herein may include single metals, alloys, and the like, but from the viewpoint of corrosion resistance, electrical resistivity, and coefficient of linear expansion, it may preferably be alloys containing at least one selected from the group consisting of Cr, Fe, Co, Ni, Cu, Al, and Ti, and more preferably stainless steel, Fe-Ni alloy, and phosphor bronze.

The size and shape of the terminal 29 are not particularly limited. For example, as shown in FIG. 2A, the terminals 29 can be provided on the whole of the pair of electrodes 28a, 28b on the outer peripheral wall 23. Further, the terminals 29 may be provided on a part of the pair of electrodes 28a, 28b on the outer peripheral wall 23, or may be provided so as to extend toward an outer side than the outer edge of each of the pair of electrodes 28a, 28b on the outer peripheral wall 23.

Further, the terminals 29 may be provided on a part of the pair of electrodes 28a, 28b on the partition walls 26, or may be provided so as to block a part of the cells 25.

Furthermore, the thickness of the terminal 29 is not particularly limited, but it is, for example, 0.01 to 10 mm, typically 0.05 to 5 mm.

The method of connecting the terminals 29 to the pair of electrodes 28a, 28b is not particularly limited as long as they are electrically connected. For example, they can be connected by diffusion bonding, a mechanical pressing mechanism, welding, or the like.

### 2-4. Adsorbing Layer 27

The adsorbing layer 27 contains an adsorbent.

The adsorbing layer 27 can be provided on the surfaces of the partition walls 26 (in the case of the outermost cells 25, the partition walls 26 that define the outermost cells 25 and the outer peripheral wall 23). By thus providing the adsorbing layer 27, the moisture, CO2 and the like are easily adsorbed during the adsorption process, and the adsorbing layer 27 can be easily heated during the regeneration process, so that the desired function by the adsorbing layer 27 can be regenerated.

The adsorbing layer 27 is preferably capable of adsorbing one or more selected from moisture, carbon dioxide and volatile components. Specifically, the adsorbing layer 27 can contain at least one adsorbent that can adsorb these components. If one adsorbent can adsorb all the moisture, carbon dioxide and volatile components, the moisture, the carbon dioxide and the volatile components can be adsorbed by including only that adsorbent. By containing such an adsorbent, it is possible to obtain an effect of purifying the air.

The adsorbent contained in the adsorbing layer 27 preferably has a function that can adsorb the moisture, CO₂ and the like at −20 to 40° C. and release them at an elevated temperature of 60° C. or more.

Examples of the adsorbent include, but not limited to, aluminosilicate, silica gel, silica, graphene oxide, polymer adsorbents, polystyrene sulfonic acid, zeolite, activated carbon, alumina, low-crystalline clay, amorphous aluminum silicate composites, and metal organic frameworks (MOFs). These may be used alone or in combination of two or more.

Examples of the aluminosilicate that can be preferably used herein include AFI type-, CHA type-, or BEA type-zeolite; porous clay minerals such as allophane and imogolite. Also, it is more preferable that the aluminosilicate is amorphous.

Examples of the silica gel that can be preferably used herein include type A silica gel.

Examples of the polymer adsorbent that can be preferably used herein include a polymer adsorbent having a polyacrylic acid polymer chain. For example, sodium polyacrylate or the like can be used as the polymer adsorbent.

The metal organic framework is a crystalline hybrid material containing metal ions and organic molecules (organic ligands). The metal ions are preferably hydrophilic metal ions (for example, aluminum ions).

The volatile components in the air in the vehicle interior are, for example, volatile organic compounds (VOCs) and odor components other than the VOCs.

Specific examples of the volatile components include ammonia, acetic acid, isovaleric acid, nonenal, formaldehyde, toluene, xylene, paradichlorobenzene, ethylbenzene, styrene, chlorpyrifos, di-n-butyl phthalate, tetradecane, and di-2-ethylhexyl phthalate, diazinon, acetaldehyde, 2-(1-methylpropyl)phenyl N-methylcarbamate, and the like.

The adsorbing layer 27 can contain a catalyst. By containing the catalyst, it is possible to promote oxidation-reduction reaction and the like to purify carbon dioxide and/or volatile components. The catalyst having such a function includes metal catalysts such as Pt, Pd and Ag, and oxide catalysts such as CeO₂ and ZrO₂. The catalyst may be used alone or in combination of two or more types. The catalyst may also be used in combination with the functional material as described above.

The thickness of the adsorbing layer 27 may be determined according to the size of the cells 25, and is not particularly limited. For example, the thickness of the adsorbing layer 27 is preferably 20 μm or more, and more preferably 25 μm or more, and even more preferably 30 μm or more, from the viewpoint of ensuring sufficient contact with air. On the other hand, the thickness of the adsorbing layer 27 is preferably 400 μm or less, and more preferably 380 μm or less, and even more preferably 350 μm or less, from the viewpoint of suppressing separation of the adsorbing layer 27 from the partition walls 26 and the outer peripheral wall 23.

The thickness of the adsorbing layer 27 is measured using the following procedure. Any cross section parallel to the flow path direction of the honeycomb structure 21 is cut out, and a cross-sectional image at magnifications of about 50 is acquired using a scanning electron microscope or the like. Also, this cross section is made to pass through the center of gravity position in the cross section orthogonal to the flow path of the honeycomb structure 21. The thickness of each adsorbing layer 27 visually recognized from the cross-sectional image is calculated by dividing the cross-sectional area by the length of the cells 25 in the flow path direction. This calculation is performed for all the adsorbing layers 27 visually recognized from the cross-sectional image, and an average value thereof is determined to be the thickness of the adsorbing layer 27.

From the viewpoint of exerting a desired function in the air conditioning device 20, an amount of the adsorbing layer 27 is preferably 50 to 500 g/L, and more preferably 100 to 400 g/L, and even more preferably 150 to 350 g/L, based on the volume of the honeycomb structure 21. It should be noted that the volume of the honeycomb structure 21 is a value determined by the external dimensions of the honeycomb structure 21.

### 2-5. Method for Producing Air Conditioning Device 20

The method for producing the air conditioning device 20 according to the embodiment of the present invention is not particularly limited, and it can be performed according to a known method. Hereinafter, the method for producing the air conditioning device 20 according to an embodiment of the present invention will be illustratively described.

A method for producing the honeycomb structure 21 forming the air conditioning device 20 includes a forming step and a firing step.

In the forming step, a green body containing a ceramic raw material including BaCO₃ powder, TiO₂ powder, and rare earth nitrate or hydroxide powder is formed to prepare a honeycomb formed body having a relative density of 60% or more.

The ceramic raw material can be obtained by dry-mixing the powders so as to have a desired composition.

The green body can be obtained by adding a dispersion medium, a binder, a plasticizer and a dispersant to the ceramic raw material and kneading them. The green body may optionally contain additives such as shifters, metal oxides, property improving agents, and conductor powder.

The blending amount of the components other than the ceramic raw material is not particularly limited as long as the relative density of the honeycomb formed body is 60% or more.

As used herein, the “relative density of the honeycomb formed body” means a ratio of the density of the honeycomb formed body to the true density of the entire ceramic raw material. More particularly, the relative density can be determined by the following equation:

relative density of honeycomb formed body (%)=density of honeycomb formed body (g/cm³)/true density of entire ceramic raw material (g/cm³)×100.

The density of the honeycomb formed body can be measured by the Archimedes method using pure water as a medium. Further, the true density of the entire ceramic raw material can be obtained by dividing the total mass of the respective raw materials (g) by the total volume of the actual volumes of the respective raw materials (cm³).

Examples of the dispersion medium include water or a mixed solvent of water and an organic solvent such as alcohol, and more preferably water.

Examples of the binder include organic binders such as methyl cellulose, hydroxypropoxyl cellulose, hydroxyethyl cellulose, carboxymethyl cellulose, and polyvinyl alcohol. In particular, it is preferable to use methyl cellulose in combination with hydroxypropoxyl cellulose. The binder may be used alone, or in combination of two or more, but it is preferable that the binder does not contain an alkali metal element.

Examples of the plasticizer include polyoxyalkylene alkyl ethers, polycarboxylic acid-based polymers, and alkyl phosphate esters.

The dispersant that can be used herein includes surfactants such as polyoxyalkylene alkyl ether, ethylene glycol, dextrin, fatty acid soaps, and polyalcohol. The dispersant may be used alone or in combination of two or more.

The honeycomb formed body can be produced by extrude the green body. In the extrusion, a die having a desired overall shape, cell shape, partition wall thickness, cell density and the like can be used.

The relative density of the honeycomb formed body obtained by extrusion is 60% or more, and preferably 65% or more. By controlling the relative density of the honeycomb formed body to such a range, the honeycomb formed body can be densified and the electrical resistance at room temperature can be reduced. The upper limit of the relative density of the honeycomb formed body is not particularly limited, but it may generally be 80%, and preferably 75%.

The honeycomb formed body can be dried before the firing step. Non-limiting examples of the drying method include conventionally known drying methods such as hot air drying, microwave drying, dielectric drying, drying under reduced pressure, drying in vacuum, and freeze drying. Among these, a drying method that combines the hot air drying with the microwave drying or dielectric drying is preferable in that the entire formed body can be rapidly and uniformly dried.

The firing step includes maintaining the formed body at a temperature of from 1150 to 1250° C., and then increasing the temperature to a maximum temperature of from 1360 to 1430° C. at a heating rate of 20 to 600 ° C./hour, and maintaining the temperature for 0.5 to 10 hours.

The maintaining of the honeycomb formed body at the maximum temperature of from 1360 to 1430° C. for 0.5 to 10 hours can provide the honeycomb structure 21 containing, as a main component, BaTiO₃-based crystal particles in which a part of Ba is substituted with the rare earth element.

Further, the maintaining at the temperature of from 1150 to 1250° C. can allow the Ba₂TiO₄ crystal particles generated in the firing process to be easily removed, so that the honeycomb structure 21 can be densified.

Further, the heating rate of 20 to 600 °C./hour from the temperature of 1150 to 1250° C. to the maximum temperature of 1360 to 1430° C. can allow 1.0 to 10.0% by mass of Ba₆Ti₁₇O₄₀ crystal particles to be formed in the honeycomb structure 21.

The maintaining time at 1150 to 1250° C. is not particularly limited, but it may preferably be from 0.5 to 10 hours. Such a maintaining time can lead to stable and easy removal of Ba₂TiO₄ crystal particles generated in the firing process.

The firing step preferably includes maintaining at 900 to 950° C. for 0.5 to 5 hours during the increasing of the temperature. The maintaining at 900 to 950° C. for 0.5 to 5 hours can lead to sufficient decomposition of BaCO₃, so that the honeycomb structure 21 having a predetermined composition can be easily obtained.

Prior to the firing step, a degreasing step for removing the binder may be performed. The degreasing step may preferably be performed in an air atmosphere in order to decompose the organic components completely.

Also, the atmosphere of the firing step may preferably be the air atmosphere in terms of control of electrical characteristics and production cost.

A firing furnace used in the firing step and the degreasing step is not particularly limited, but it may be an electric furnace, a gas furnace, or the like.

The pair of electrodes 28a, 28b is formed on the honeycomb structure 21 thus obtained. The pair of electrodes 28a, 28b can be formed by metal deposition methods such as sputtering, vapor deposition, electrolytic deposition, and chemical deposition. Further, the pair of electrodes 28a, 28b can also be formed by applying an electrode paste and then baking it. Furthermore, the pair of electrodes 28a, 28b can also be formed by thermal spraying. The pair of electrodes 28a, 28b may be composed of a single layer, but may also be composed of a plurality of electrode layers having different compositions. A typical method for forming the pair of electrodes 28a, 28b will be described below.

First, an electrode slurry containing an electrode material, an organic binder, and a dispersion medium is prepared, and the first end face 24a or the second end face 24b of the honeycomb structure 21 is coated with the slurry. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. An excess slurry on the periphery of the honeycomb structure 21 is removed by blowing and wiping. The slurry can be then dried to form the pair of electrodes 28a, 28b on the first end face 24a or the second end face 24b of the honeycomb structure 21. The drying can be performed while heating the honeycomb structure 21 to a temperature of about 120 to 600° C., for example. Although a series of steps of coating, slurry removal, and drying may be performed only once, the steps can be repeated multiple times to provide the pair of electrodes 28a, 28b having desired thicknesses.

The terminals 29 are then disposed at predetermined positions of the pair of electrodes 28a, 28b, and the pair of electrodes 28a, 28b and the terminals 29 are connected to each other. As a method of connecting the pair of electrodes 28a, 28b to the terminals 29, the method described above can be used.

It should be noted that the terminals 29 may be disposed after forming an adsorbing layer 27 described below.

The adsorbing layer 27 is then formed on the surfaces of the partition walls 26 and the like of the honeycomb structure 21.

Although the method for forming the adsorbing layer 27 is not particularly limited, it can be formed, for example, by the following steps. The honeycomb structure 21 is immersed in a slurry containing an adsorbent, an organic binder, and a dispersion medium for a predetermined period of time, and an excess slurry on the end faces and the outer periphery of the honeycomb structure 21 is removed by blowing and wiping. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof.

The slurry can be then dried to form the adsorbing layer 27 on the surfaces of the partition walls 26. The drying can be performed while heating the honeycomb structure 21 to a temperature of about 120 to 600° C., for example. Although a series of steps of immersion, slurry removal, and drying may be performed only once, the steps can be repeated multiple times to provide the adsorbing layer 27 having the desired thickness on the surfaces of the partition walls 26 and the like.

### 3. Power Source 40

The power source 40 is for applying a voltage to the air conditioning device 20 (in particular, the pair of electrodes 28a, 28b). The power source 40 is electrically connected to the control unit 30, and adjusts the state of the voltage applied to the pair of electrodes 28a, 28b according to instructions from the control unit 30.

The power source 40 is not particularly limited, and a battery or the like can be used.

### 4. Ventilation Fan 60

The ventilation fan 60 is a device for allowing air from the vehicle interior or the vehicle exterior to flow into the air conditioning device 20, and is disposed in the air conditioning duct 10. The position of the ventilation fan 60 is not limited, but it may be on the upstream side of the air conditioning device 20, for example, as shown in FIG. 1, or on the downstream side of the air conditioning device 20.

The ventilation fan 60 is electrically connected to the control unit 30 and can control the flow velocity of the air by adjusting the rotation speed according to instructions from the control unit 30.

### 5. Control Unit 30

Also, the control unit 30 is electrically connected to the power source 40, the valve 50, the ventilation fan 60, and the like, and it can control these members. The control unit 30 can control the power source 40, thereby adjusting the heating state of the honeycomb structure 21 by controlling a voltage applying state to the pair of electrodes 28a, 28b of the air conditioning device 20. Further, the control unit 30 can also control the valve 50 so that the air flows through the first flow path 10a or the second flow path 10b. Furthermore, the control unit 30 can adjust the rotation speed of the ventilation fan 60, thereby controlling the flow velocity of the air flowing through the air conditioning duct 10.

The control unit 30 is generally an ECU (Engine (electronic) Control Unit), although not particularly limited thereto. The ECU is a CPU for executing various calculation processes, a ROM for storing programs and data required for its control, a RAM for temporarily storing results of calculations performed by the CPU, and input/output ports for inputting and outputting signals to and from the outside.

The control unit 30 is capable of performing an adsorption process for turning off the applied voltage from the power source 40 and switching the valve 50 so that the air flowing through the air conditioning duct 10 passes through the first flow path 10a, and a regeneration process for turning on the applied voltage from the power source 40 and switching the valve 50 so that the air flowing through the air conditioning duct 10 passes through the second flow path 10b. By performing the adsorption process and the regeneration process in such a manner, these processes can be efficiently carried out.

In the case of adsorption process, moisture and CO₂ in the air flowing from the vehicle interior or the vehicle exterior are trapped (adsorbed) by the control unit 30 as described above. At this time, the honeycomb structure 21 of the air conditioning device 20 is not heated. Specifically, the air from the vehicle interior or the vehicle exterior flows in the air conditioning device 20 through the air conditioning duct 10, and the moisture, CO₂ and the like contained in the air are trapped. The air that has trapped the moisture, CO₂ and the like is returned to the vehicle interior through the first flow path 10a.

In the case of adsorption process, by controlling the control unit 30 as described above, the adsorbing layer 27 of the air conditioning device 20 is regenerated. At this time, the honeycomb structure 21 of the air conditioning device 20 is heated. Specifically, the air from the vehicle interior or the vehicle exterior flows in the air conditioning device 20 through the air conditioning duct 10, and separates the moisture, CO₂ and the like trapped in the adsorbing layer 27 while passes through the air conditioning device 20. Then, the air containing the moisture is discharged to the vehicle exterior through the second path 10b.

From the viewpoint of stably performing the above control, it is desirable that the air conditioning device 20 be placed at a position close to the vehicle interior. Therefore, from the viewpoint of preventing electric shock and the like, it is preferable that the driving voltage of the air conditioning device 20 is 60V or less.

Since the honeycomb structure 21 used in the air conditioning device 20 has a low electrical resistance at room temperature, the honeycomb structure 21 can be heated at the low driving voltage. It should be noted that the lower limit of the driving voltage is not particularly limited, but it may preferably be 10 V or more. If the driving voltage is less than 10V, the current during heating the honeycomb structure 21 becomes large, so that the conductor wire should be thick.

### Method for Using Air Conditioning Device

In the method for using the air conditioning device 20 according to an embodiment of the present invention, at the end period of the regeneration process of the adsorbing layer 27 and/or during the adsorption process after the regeneration process, the control unit 30 controls the flow velocity of the air when the adsorbing layer 27 is above the adsorption temperature to be higher than the flow velocity of the air when the adsorbing layer 27 is below the adsorption temperature. By controlling the flow velocity (flow rate) of the air in this manner, when the adsorbing layer 27 is above the adsorption temperature, the flow velocity of the air is rapidly increased to facilitate the cooling of the adsorbing layer 27, thus enabling a smooth transition from the regeneration process to the adsorption process.

The above control is preferably performed within 15 seconds from the end of the regeneration process. Specifically, when the above control is performed during the adsorption process after the regeneration process of the adsorbing layer 27 or at the end period of the regeneration process of the adsorbing layer 27 and during the adsorption process after the regeneration process, the above control is preferably completed within 15 seconds from the end of the regeneration process.

Such a control allows the adsorption process to be rapidly started. Also, as the flow velocity of the air is increased, noise is more likely to occur due to the increased rotation speed of the ventilation fan 60. However, by performing the above control within 15 seconds from the end of the regeneration process, the period during which noise is likely to occur can be shortened.

The regeneration process and the adsorption process can be performed as needed depending on the humidity in the vehicle interior, but if the humidity in the vehicle interior is higher, the regeneration process and the adsorption processes are preferably repeated. By repeating the regeneration process and the adsorption process, even if the moisture adsorbed on the adsorbing layer 27 is saturated, the moisture adsorbed on the adsorbing layer 27 can be separated by the regeneration process, and the moisture can be adsorbed immediately thereafter by the adsorption process, thus efficiently reducing the humidity in the vehicle interior.

From the viewpoint of efficient cooling of the adsorbing layer 27, the ratio of the flow velocity of the air when the adsorbing layer 27 is above the adsorption temperature to the flow velocity of the air when the adsorbing layer 27 is below the adsorption temperature is preferably 1.1 or more, and more preferably 1.2 or more, and even more preferably 1.3 or more.

The upper limit of the ratio of the flow velocity of the air when the adsorbing layer 27 is above the adsorption temperature to the flow velocity of the air when the adsorbing layer 27 is below the adsorption temperature is not particularly limited, but from the viewpoint of suppressing noise due to an increase in the rotation speed of the ventilation fan 60, it is preferably 4.0 or less, and more preferably 3.5 or less, and further preferably 3.0 or less.

The flow velocity of the air when the adsorbing layer 27 is above the adsorption temperature is not particularly limited as long as the above conditions are fulfilled, but it is preferably 0.02 m/s or more, and more preferably 0.025 m/s or more, and even more preferably 0.03 m/s or more. Such a control to the flow velocity of the air allows the cooling of the adsorbing layer 27 to be efficiently carried out.

The flow velocity of the air when the adsorbing layer 27 is above the adsorption temperature is preferably 3.00 m/s or less, and more preferably 2.80 m/s or less, and even more preferably 2.50 m/s or less. Such a control can suppress the noise caused by the increased speed of the ventilation fan 60.

The air conditioning device 20 used in the method for using the air conditioning device according to the embodiment of the present invention is described above, and detailed descriptions thereof are omitted.

### DESCRIPTION OF REFERENCE NUMERALS

10 air conditioning duct
10a first flow path
10b second flow path
20 air conditioning device
21 honeycomb structure
23 outer peripheral wall
24a first end face
24b second end face
25 cell
26 partition wall
27 adsorbing layer
28a, 28b pair of electrodes
29 terminal
30 control unit
40 power source
50 valve
60 ventilation fan
100 vehicle air conditioning system

1. A vehicle air conditioning system, comprising:
an air conditioning duct through which air can flow;
an air conditioning device comprising: a honeycomb structure having an outer peripheral wall and partition walls disposed on an inner side of the outer peripheral wall, the partition walls defining a plurality of cells, each of the cells extending from a first end face to a second end face to form a flow path for the air; and an adsorbing layer formed on each surface of the partition walls, the air conditioning device being disposed in the air conditioning duct; and
a control unit capable of controlling a flow velocity of the air flowing through the cells of the air conditioning device,
wherein, at an end period of a regeneration process of the adsorbing layer and/or during a adsorption process after a regeneration process, the control unit controls the flow velocity of the air when the adsorbing layer is above an adsorption temperature to be higher than that of the air when the adsorbing layer is below the adsorption temperature.

2. The vehicle air conditioning system according to claim 1, wherein the control of the flow velocity of the air is performed within 15 seconds from the end of the regeneration process.

3. The vehicle air conditioning system according to claim 1, wherein the end period of the regeneration process is a period during the regeneration process within ¼ of a regeneration process time from the end of the regeneration process.

4. The vehicle air conditioning system according to claim 1, wherein the regeneration process and the adsorption process are repeated.

5. The vehicle air conditioning system according to claim 1, wherein a ratio of the flow velocity of the air when the adsorbing layer is above the adsorption temperature to the flow velocity of the air when the adsorbing layer is below the adsorption temperature is 1.1 or more.

6. The vehicle air conditioning system according to claim 1, wherein the flow velocity of the air when the adsorbing layer is above the adsorption temperature is 0.03 m/s or more.

7. The vehicle air conditioning system according to claim 1, wherein a temperature of the adsorbing layer is determined by previously determining a relationship between at least one condition parameter and a temperature of the adsorbing layer, the at least one condition parameter being selected from a temperature of the honeycomb structure, a resistance value of the honeycomb structure, a current value of the honeycomb structure, a heating time of the honeycomb structure, a temperature of the air passing through the honeycomb structure, and amounts of components contained in the air passing through the honeycomb structure, and then measuring the condition parameter.

8. The vehicle air conditioning system according to claim 1, further comprising a ventilation fan disposed in the air conditioning duct, wherein the control unit controls the flow velocity of the air by adjusting a rotation speed of the ventilation fan.

9. The vehicle air conditioning system according to claim 1, wherein the air conditioning duct is, on a downstream side, branched into a first flow path for allowing the air flow into the vehicle interior and a second flow path for discharging the air to a vehicle exterior, and wherein the air conditioning duct further comprises a valve capable of switching the flow of the air between the first flow path and the second flow path.

10. The vehicle air conditioning system according to claim 9, further comprising a power source for applying voltage to the air conditioning device.

11. The vehicle air conditioning system according to claim 10, wherein the control unit can perform:
an adsorption process for turning off an applied voltage from the power source and switching the valve so that the air flowing through the air conditioning duct passes through the first flow path;
a regeneration process for turning on the applied voltage from the power source and switching the valve so that the air flowing through the air conditioning duct passes through the second flow path.

12. The vehicle air conditioning system according to claim 1, wherein at least the partition walls of the honeycomb structure are made of a material having a PTC property.

13. The vehicle air conditioning system according to claim 1, wherein the humidity controlling device further comprises a pair of electrodes provided on the first end face and the second end face of the honeycomb structure, or on the outer peripheral wall parallel to an extending direction of the cells of the honeycomb structure.

14. The vehicle air conditioning system according to claim 1, wherein the adsorbent is capable of adsorbing at least one of moisture, carbon dioxide and volatile components.

15. A method for using an air conditioning device, the air conditioning device comprising: a honeycomb structure having an outer peripheral wall and partition walls disposed on an inner side of the outer peripheral wall, the partition walls defining a plurality of cells, each of the cells extending from a first end face to a second end face to form a flow path for air; and an adsorbing layer containing an adsorbent, the adsorbing layer being provided on each surface of the partition walls, the method comprising:
at an end period of a regeneration process of the adsorbing layer and/or during an adsorption process after the regeneration process, controlling a flow velocity of the air when the adsorbing layer is above an adsorption temperature to be higher than that of the air when the adsorbing layer is below the adsorption temperature.

16. The method for using the air conditioning device according to claim 15, wherein controlling the flow velocity of the air is performed within 15 seconds from the end of the regeneration process.

17. The method for using the air conditioning device according to claim 15, wherein the end period of the regeneration process is a period during the regeneration process within ¼ of a regeneration process time from the end of the regeneration process.

18. The method for using the air conditioning device according to claim 15, wherein the regeneration process and the adsorption process are repeated.

19. The method for using the air conditioning device according to claim 15, wherein a ratio of the flow velocity of the air when the adsorbing layer is above the adsorption temperature to the flow velocity of the air when the adsorbing layer is below the adsorption temperature is 1.1 or more.

20. The method for using the air conditioning device according to claim 15, wherein the flow velocity of the air when the adsorbing layer is above the adsorption temperature is 0.03 m/s or more.

21. The method for using the air conditioning device according to claim 15, wherein at least the partition walls of the honeycomb structure are made of a material having a PTC property.

22. The method for using the vehicle air conditioning device according to claim 15, wherein the air conditioning device further comprises a pair of electrodes provided on the first end face and the second end face of the honeycomb structure, or on the outer peripheral wall parallel to an extending direction of the cells of the honeycomb structure.

23. The method for using the air conditioning device according to claim 15, wherein the adsorbent is capable of adsorbing at least one of moisture, carbon dioxide and volatile components.
